(19) United States
(12) Patent Application Publication
(10) Pub. No.: US 2011/0071908 A1
(43) Pub. Date: Mar. 24, 2011

(54) EXPRESSIVE BIDDING IN ONLINE ADVERTISING AUCTIONS

(75) Inventors: Arpita Ghosh, Santa Clara, CA (US); R. Preston McAfee, San Marino, CA (US); Amin Sayedi, Pittsburgh, PA (US)

(73) Assignee: Yahoo! Inc., Synnyvale, CA (US)

(21) Appl. No.: 12/565,148

(22) Filed: Sep. 23, 2009

(51) Int. Cl. G06Q 30/00

(52) U.S. Cl. 705/14.71

(57) ABSTRACT

Methods and systems are provided that include expressive bidding techniques for use with online advertising auctions. Methods and systems are provided relating to bidding for display of an advertisement, where the bidding takes into account one or more externality conditions present upon display of the advertisement. An externality condition includes any condition associated with the presence or non-presence of other advertisements along with a subject advertisement, or associated with characteristics or circumstances relating to any such other advertisements. For example, whether an advertisement is displayed exclusively or with other advertisements is an externality condition.

### CROSS-REFERENCE TO RELATED APPLICATION

This application is related to the application entitled “EXPRESSIVE BIDDING ONLINE ADVERTISING AUCTION MECHANISMS”, Attorney Reference Number 10033-2001400, filed on even day herewith.

### BACKGROUND

In online advertising, an auction is often used, in which advertisers bid for allocation and serving of their online advertisements in connection with serving opportunities. Resulting advertisements are often displayed (or otherwise presented) along with each other. Advertisements may be displayed in a particular order, pattern or rank, or considered to be displayed in a particular order, pattern or rank, in terms of placement on a page. Generally, higher ranked or better placed advertisements are more valuable to advertisers, since they are generally more prominently displayed to users, and they are generally associated with better performance and expected revenue generation.

In online advertising, much attention has been paid to what can be considered the advertiser-user relationship, yet relatively little attention has been focused on the advertiser-advertiser relationship. In particular, little attention has been paid to the fact that performance associated with a display of a particular online advertisement (potentially including not only click through rate, but also downstream performance measures, such as conversion rates, etc.), and hence its value to an advertiser, is affected by other advertisements that are displayed together with the particular advertisement.

Furthermore, various parameters and specifics associated with such other displayed advertisements are also factors that can affect the value of a particular advertisement. For example, such parameters can include how many advertisements are displayed along with the particular advertisement, what type of advertisements they are, what technical or business areas they or associated advertisers are in, and potentially many other parameters. In general, any advertisements displayed along with a particular advertisement to some degree reduce the value to the advertiser associated with the display of the particular advertisement. Any advertisements displayed along with the particular advertisement, and any characteristics, whether direct or indirect, associated with such advertisements, can be referred to as “externalities” relative to the particular advertisement.

Existing bidding methods, systems and languages in connection with online advertising auctions do not provide advertisers with sufficient or a high level of expressivity.

There is a need for bidding methods, systems and languages that address the need for advertisers or their proxies to have greater expressivity in connection with online advertising auctions.

### SUMMARY

Some embodiments of the invention provide expressive bidding techniques or languages for use with online advertising auctions. In some embodiments, methods and systems are provided relating to bidding for display of an advertisement, where the bidding takes into account one or more externality conditions present, or anticipated or determined to be present, upon display of the advertisement. For example, methods and systems are provided in which bidding takes into account the effect, or perceived, anticipated, estimated or forecasted effect, on the value of display of an advertisement, of externality conditions. An externality condition includes any condition associated with the presence or non-presence of other advertisements along with a subject advertisement, or associated with characteristics or circumstances relating, directly or indirectly, to any such other advertisements. For example, whether an advertisement is displayed exclusively or with other advertisements is an example of an externality condition.

In some embodiments, advertisers can provide multiple bids associated with serving of an advertisement, where each of the multiple bids (which can, in some embodiments, be elements of a single multidimensional bid) is associated with a different set of externality conditions. In some embodiments, advertisers can specify two bids, including a first bid associated with display of an advertisement exclusively, and a second bid associated with display of the advertisement with other advertisements. In some embodiments, not all bidders must submit multiple bids associated with different sets of externality conditions.

Some embodiments of the invention provide auction techniques or mechanisms, for use with or to accommodate expressive bidding techniques, such as bidding in connection with exclusivity or non-exclusivity. Some embodiments provide auction mechanisms in which it is determined whether to display an exclusive advertisement or multiple advertisements based at least in part on pertinent bids. In some embodiments, pricing associated with display of advertisements is determined such that the pricing deters or disincentivizes over-bidding, or bidding higher than that which is based on or proportional to value, for example, to ensure an exclusive display outcome or a multiple display outcome.

### BRIEF DESCRIPTION OF THE DRAWINGS

FIG. 1 is a distributed computer system according to one embodiment of the invention;

FIG. 2 is a simplified flow diagram illustrating a method according to one embodiment of the invention;

FIG. 3 is a conceptual block diagram illustrating one embodiment of the invention;

FIG. 4 is a simplified flow diagram illustrating a method according to one embodiment of the invention;

FIG. 5 is a simplified flow diagram illustrating a method according to one embodiment of the invention;

FIG. 6 is a simplified flow diagram illustrating a method according to one embodiment of the invention; and

FIG. 7 is a simplified flow diagram illustrating a method according to one embodiment of the invention.

### DETAILED DESCRIPTION

Herein, the term “advertiser” broadly includes anyone, any entity, or any automated system that acts or facilitates action on behalf of an advertiser or an advertising campaign associated with an advertiser, and the term “bidding” broadly includes both human and automated techniques. Herein, a serving opportunity or particular serving opportunity can include forecasted, future, or equivalent serving opportunities.

Some embodiments of the invention provide expressive bidding techniques or auction mechanisms that take into account effects of externalities on value to advertisers. By allowing such bidding techniques, advertisers can express value in connection with the effects of externalities, thereby increasing the effectiveness and return on investment associated with their advertising campaigns. This can incentivize advertisers to increase online advertising budgets, as well as attract new advertisers. Auction mechanisms are also provided to allow use and implementation of such expressive bidding and yet provide good auction properties, including fairness, efficiency and revenue properties.

Auction mechanisms are provided that allow more efficient operation of auctions that allow such expressive bidding, from the perspectives of the auction provider, advertisers, and the marketplace as a whole. Some embodiments of the invention provide auction mechanisms that, while new and non-obvious over existing auction systems, can yet be relatively easily implemented by modification of or addition to existing Generalized Second Price (or “GSP”) auction formats and associated computer-related implementation platforms, hardware and software. Furthermore, some embodiments do not cause changes, or cause minimal changes, from the advertiser experience perspective, relative to GSP auction formats. Other auction mechanisms are provided that differ more from GSP auction formats.

Some embodiments of the invention provide expressive bidding techniques for use with online advertising auctions. In some embodiments, methods and systems are provided for bidding for display of an advertisement, where the bidding takes into account externality conditions present upon display of the advertisement. For example, methods and systems are provided in which bidding takes into account the effects, or perceived, anticipated, estimated or forecasted effects, on the value of display of the advertisements, of the externality conditions.

In some embodiments, advertisers can provide multiple bids associated with serving of an advertisement, where each of the multiple bids is associated with a different set of externality conditions. In some embodiments, advertisers can specify two bids, including a first bid associated with display of an advertisement exclusively, and a second bid associated with display of the advertisement with other advertisements.

Some embodiments of the invention provide methods and systems that relate to online advertising auctions and auction mechanisms. Methods and systems are provided that provide auction operation techniques, or auction mechanisms, that allow bidding that takes into account externalities. For example, methods and systems relating to auction operation are provided in which bidding takes into account the effect, or perceived, anticipated, estimated or forecasted effect, on the value of display of the advertisements, of the externality conditions. An externality condition includes any condition associated with the presence or non-presence of other advertisements along with a subject advertisement, or associated with characteristics or circumstances relating to any such other advertisements.

Oline advertising Auction operation may be based in part on such expressive bidding. For example, determination of whether to display an advertisement exclusively or to display multiple advertisements may be based at least in part on pertinent exclusive and non-exclusive bids. Other auction operations, including pricing and serving, may be based at least in part on the determination and the particular advertisement or advertisements displayed.

Herein, in situations where comparisons between values yield an equality, various known methods may be used in making a determination, such as a determination as to which outcome may be most beneficial or desirable to an auction operator or facilitator.

Some embodiments of the invention are described relative to a known GSP auction format. A GSP auction mechanism, as the term is used herein, refers to a known mechanism that does not include variable or multi-dimensional bidding based on different externality conditions, such as bidding in connection with exclusivity. In a GSP auction, in connection with a particular serving opportunity, one or more available advertising slots are filled with matching advertisement displays. Winners of the slots may be based, for example, on a bid alone, or a term including bid and one or more other factors, such as bid multiplied by an associated click through rate, which may be a determined, forecasted or estimated click through rate. Other terms, variables or constants can also be included in more complex terms. Pricing for each slot is generally determined based on the bid (or term including bid) associated with the next lower pertinent bid. So, for example, pricing for a first slot is determined based on the bid or bid term associated with the second slot, such as by setting the price at, or at a minimum amount more than, the bid or bid term associated with the second slot, etc.

It is to be understood that, while bidding and auction mechanisms are described herein for simplicity in connection with a bid term that includes only the bid, the invention contemplates embodiments in which more complex bid terms are utilized, including in determinations relating to exclusive or multiple advertisement display outcomes, and in determining pricing.

A “pertinent bid”, as the term is used herein, includes any bid appropriately used in determining or helping to determine an outcome or pricing associated with one or more advertisement displays in connection with a serving opportunity. A “pertinent bid” includes a bid associated with display of an advertisement to be shown in connection with a serving opportunity if the determination of whether to display an exclusive advertisement or multiple advertisements would include display of an advertisement associated with the bid.

In GSP2d auctions and auction mechanisms according to embodiments of the invention, a “pertinent bid” further includes a K+1 bid, which is the bid that would correspond to a next slot following all allocated slots, with K representing all allocated multiple display slots, and where allocated multiple display slots are slots allocated for display of advertisements should a multiple display outcome be determined.

Some embodiments provide an auction or auction mechanism, referred to herein as a GSP2d Auction or GSP2d Auction mechanism, in which a determination of whether to display an exclusive advertisement or multiple advertisements is based a comparison of (A) a highest pertinent exclusive bid, with (B) the sum of all pertinent non-exclusive display bids from the second highest to the K+1 bid, where K is the number of allocated multiple display slots should a multiple display outcome be determined. As such, the K-+1 bid is the bid, if any, that would correspond to a next slot following all allocated multiple display slots. Pricing in some embodiments of GSP2d auction mechanisms is discussed herein.

Other embodiments provide an auction or auction mechanism, referred to herein as a Next Price auction or Next Price auction mechanism, in which a determination of whether to display an exclusive advertisement or multiple advertisements is based on a comparison of a highest pertinent exclusive advertisement display bid with the sum of all pertinent non-exclusive display bids including the highest pertinent non-exclusive display bid. Pricing can be based on a technique in which each winning bidder pays the higher of two amounts. One of the two amounts is based on the next highest pertinent exclusive or non-exclusive bid, as appropriate. In some embodiments, the other of the two amounts is conceptually based on an amount, for a particular bid, that would have to have been bid in order to assure the outcome type associated with the bid, as detailed further herein.

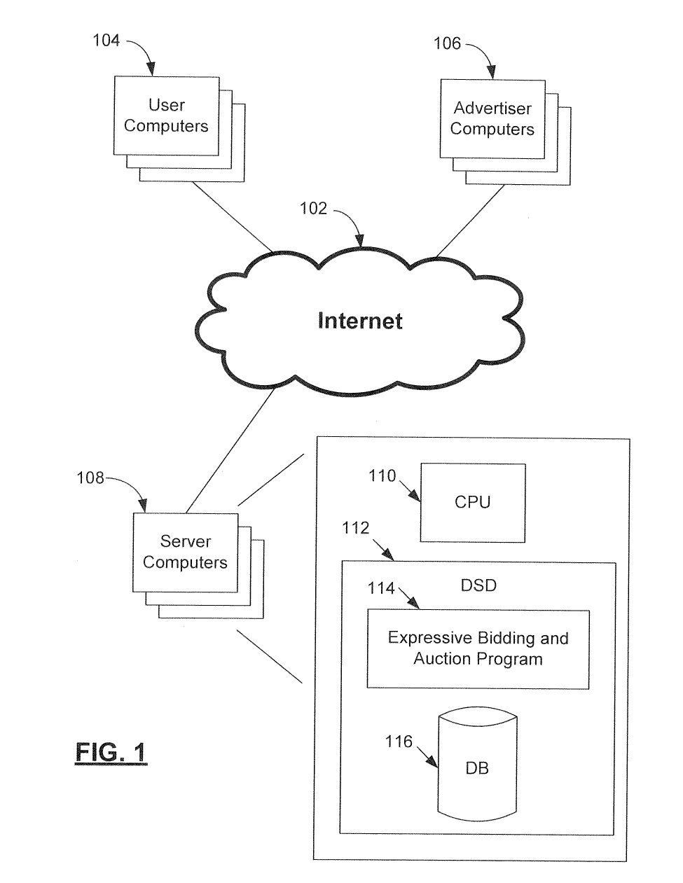

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as graphical or banner advertising as well as keyword searching and advertising in a sponsored search context. All types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Expressive Bidding and Auction Program 114.

The Expressive Bidding and Auction Program 114 is intended to broadly include all programming, applications, software and other and tools necessary to implement or facilitate methods and systems according to embodiments of the invention, whether on a single server computer or distributed among multiple computers of devices.

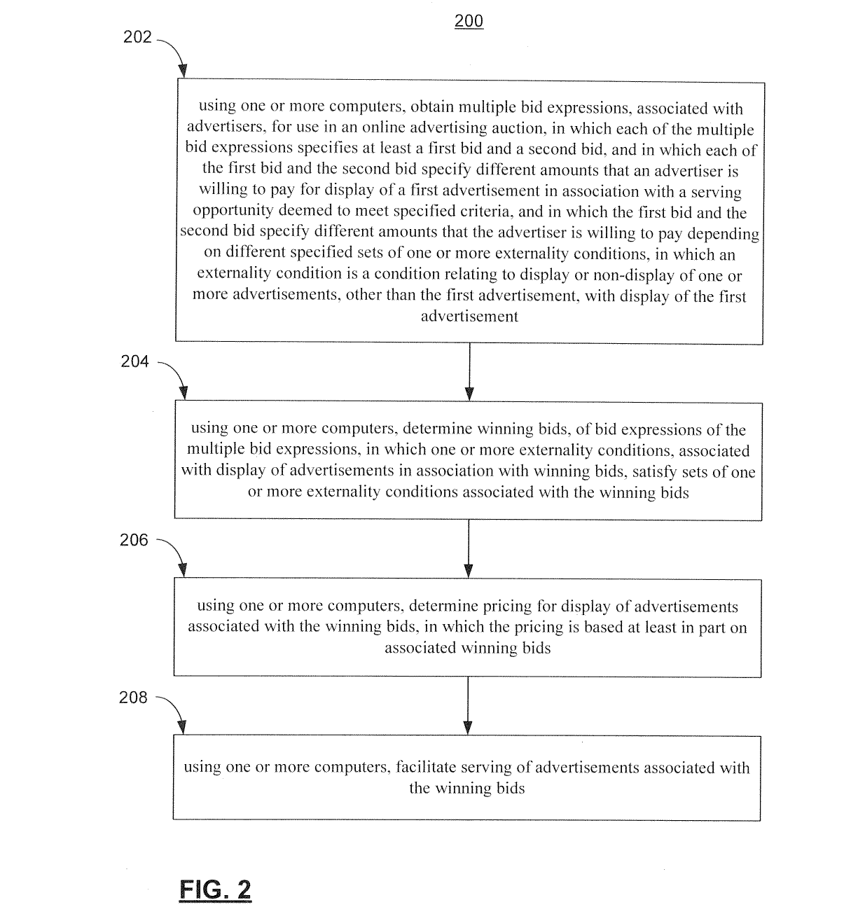

FIG. 2 is a simplified flow diagram illustrating a method 200 according to one embodiment of the invention.

At step 202, using one or more computers, multiple bid expressions associated with advertisers are obtained for use in an online advertising auction. Each of the multiple bid expressions specifies at least a first bid and a second bid. Each of the first bid and the second bid specify different amounts that an advertiser is willing to pay for display of a first advertisement in association with a serving opportunity deemed to meet specified criteria. The first bid and the second bid specify different amounts that the advertiser is willing to pay depending on different specified sets of one or more externality conditions, an externality condition being any condition relating to display or non-display of one or more advertisements, other than the first advertisement, with display of the first advertisement.

At step 204, using one or more computers, winning bids are determined, of bid expressions of the multiple bid expressions. One or more externality conditions, associated with display of advertisements in association with winning bids, satisfy sets of one or more externality conditions associated with the winning bids.

At step 206, using one or more computers, pricing is determined for display of advertisements associated with the winning bids, in which the pricing is based at least in part on associated winning bids.

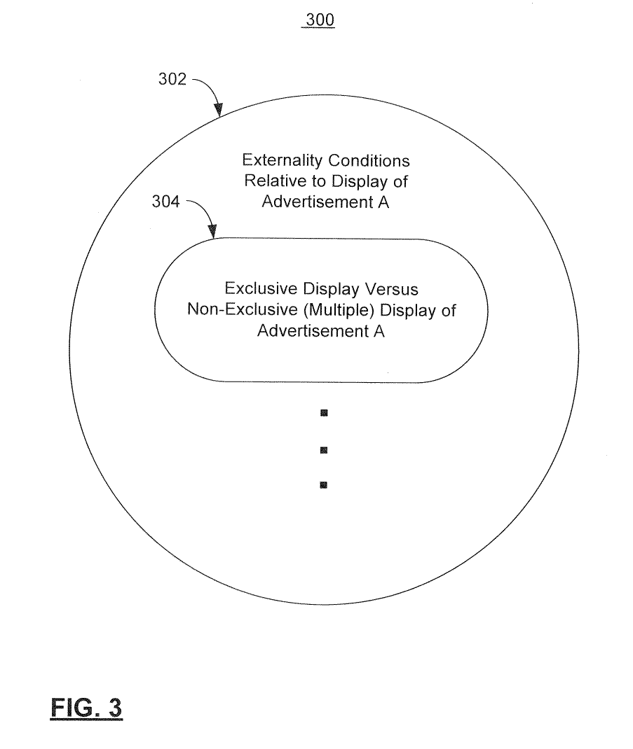

FIG. 3 is a conceptual block diagram 300 illustrating one embodiment of the invention. Outer circle 302 conceptually represents the universe of externality conditions relative to display of advertisement A. Inner circle 304 represents the particular externality condition of whether display of advertisement A is exclusive or non-exclusive. Of course, many other externality conditions may exist, including non-binary conditions. These may relate to any characteristics, parameters, etc. associated with display of advertisements with display of advertisement A.

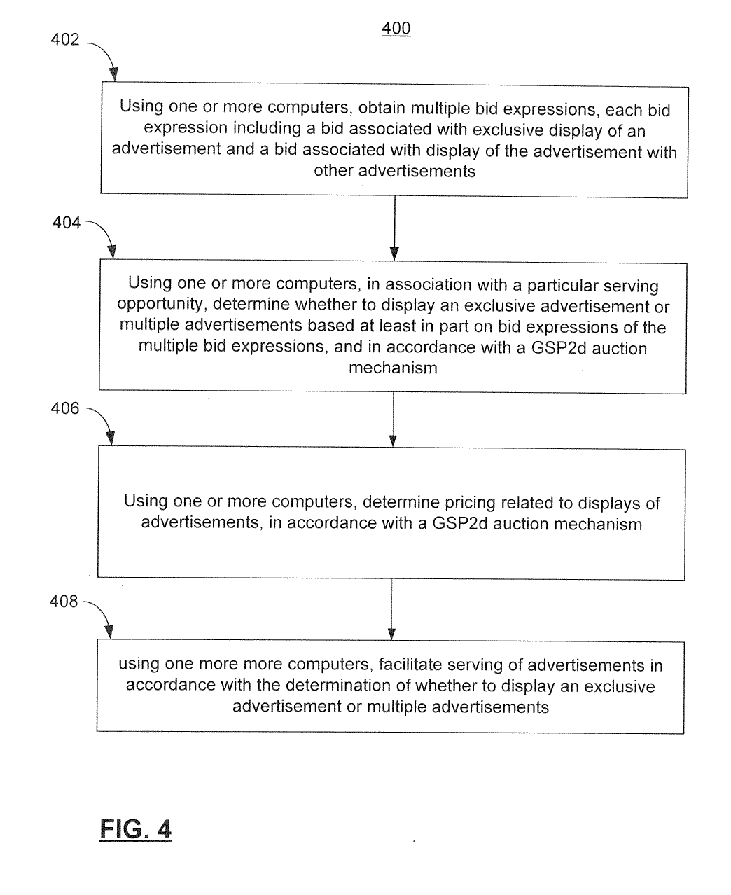

FIG. 4 is a simplified flow diagram illustrating a method 400 according to one embodiment of the invention.

At step 402, using one or more computers, multiple bid expressions are obtained, each bid expression including a bid associated with exclusive display of an advertisement and a bid associated with display of the advertisement with other advertisements.

At step 404, using one or more computers, in association with a particular serving opportunity, it is determined whether to display an exclusive advertisement or multiple advertisements based at least in part on bid expressions of the multiple bid expressions, and in accordance with a GSP2d auction mechanism.

At step 406, using one or more computers, pricing is determined relating to displays of advertisements, in accordance with a GSP2d auction mechanism.

At step 408, using one more computers, serving of advertisements is facilitated in accordance with the determination of whether to display an exclusive advertisement or multiple advertisements.

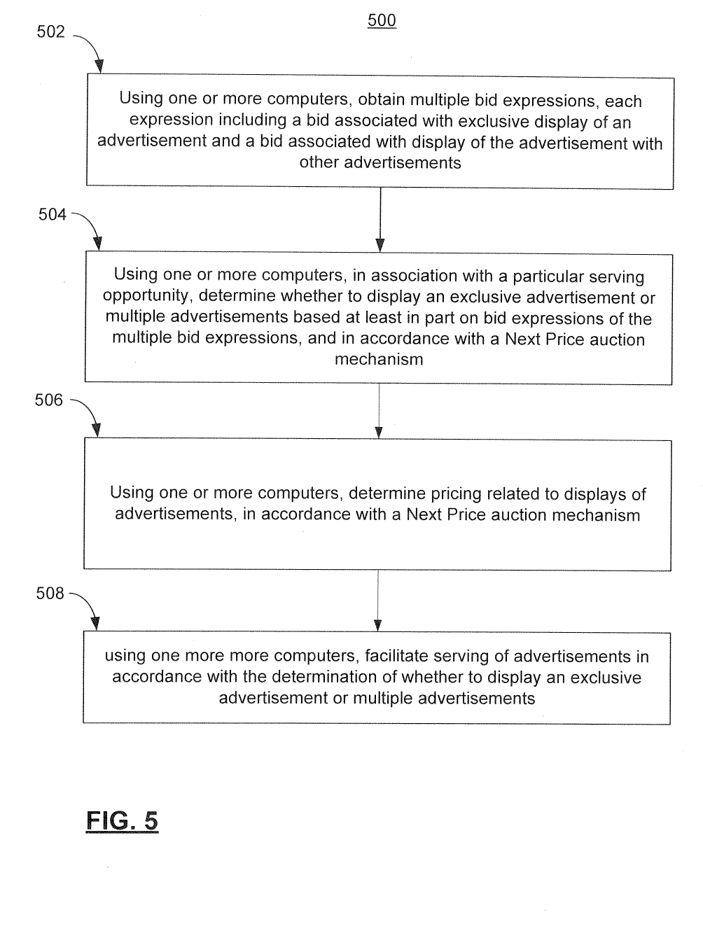

FIG. 5 is a simplified flow diagram illustrating a method 500 according to one embodiment of the invention.

At step 502, using one or more computers, multiple bid expressions are obtained, each bid expression including a bid associated with exclusive display of an advertisement and a bid associated with display of the advertisement with other advertisements.

At step 504, using one or more computers, in association with a particular serving opportunity, it is determined whether to display an exclusive advertisement or multiple advertisements based at least in part on bid expressions of the multiple bid expressions, and in accordance with a Next Price auction mechanism.

At step 506, using one or more computers, pricing is determined relating to displays of advertisements, in accordance with a Next Price auction mechanism.

At step 508, using one more computers, serving of advertisements is facilitated in accordance with the determination of whether to display an exclusive advertisement or multiple advertisements.

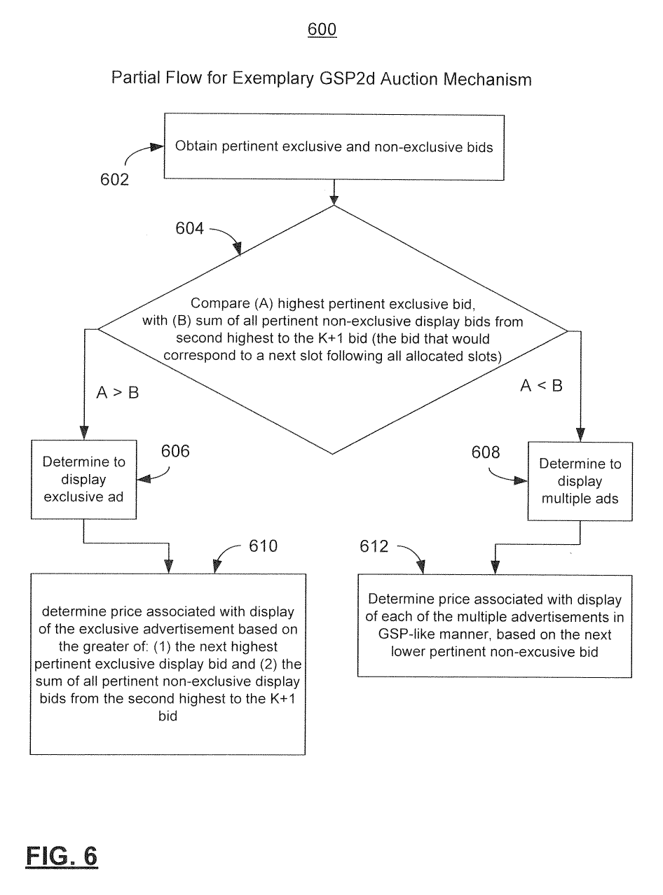

FIG. 6 is a simplified flow diagram illustrating a method 600 according to one embodiment of the invention. Specifically, FIG. 6 illustrates a partial flow for an exemplary GSP2d auction mechanism according to one embodiment of the invention.

At step 602, pertinent exclusive and non-exclusive bids are obtained.

At step 604, the method 600 compares (A) highest pertinent exclusive bid, with (B) sum of all pertinent non-exclusive display bids from second highest to the K+1 bid (the bid that would correspond to a next slot following all allocated slots).

If A is greater than B, then the method 600 proceeds to step 606, at which it is determined to display an exclusive advertisement. Following step 606, the method 600 proceeds to step 610, at which the method 600 determines a price associated with display of the exclusive advertisement based on the greater of: (1) the next highest pertinent exclusive display bid and (2) the sum of all pertinent non-exclusive display bids from the second highest to the K+1 bid.

If A is less than B, then the method 600 proceeds to step 608, at which it is determined to display multiple advertisements. Following step 608, the method 600 proceeds to step 612, at which the method 600 determines a price associated with display of each of the multiple advertisements based on in GSP-like manner, in which pricing for each display slot is determined based on the bid associated with the next lower pertinent bid relative to the bid associated with the slot for which a price is being determined.

In GSP2d auction mechanism pricing according to embodiments as described in FIG. 6, over-bidding to assure an exclusive or multiple display outcome can be deterred. For example, if the highest exclusive bidder bids excessively high, she may ensure an exclusive outcome, but even if the second highest exclusive bid is very low, she will at least be priced an amount corresponding to the sum of all pertinent multiple display bids from the second highest to the K+1 bid. Furthermore, over-bidding by non-exclusive bidders can be deterred. For example, even if the highest non-exclusive bidder bids excessively high, she will not be able to assure a multiple display outcome, since the highest pertinent non-exclusive bid is not included when determining whether to display an exclusive or multiple advertisements at step 604. Yet, if a multiple display outcome is determined, pricing is determined in a GSP-like manner, in which pricing for each display slot is determined based on the bid associated with the next lower pertinent bid.

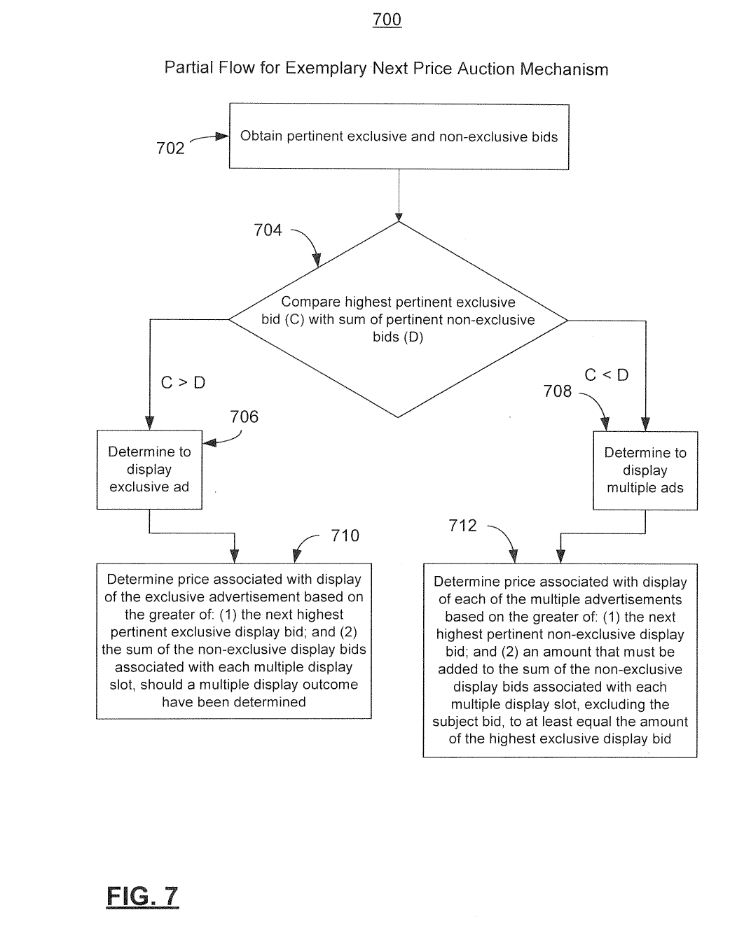

FIG. 7 is a simplified flow diagram illustrating a method 600 according to one embodiment of the invention. Specifically, FIG. 7 illustrates a partial flow for an exemplary Next Price auction mechanism according to one embodiment of the invention.

At step 702, pertinent exclusive and non-exclusive bids are obtained.

At step 704, the method 700 compares the highest pertinent exclusive bid (C) with sum of all pertinent non-exclusive bids (D).

If C is greater than D, then the method 700 proceeds to step 706, at which it is determined to display an exclusive advertisement. Following step 706, the method 700 proceeds to step 710, at which the method 700 determines a price associated with display of the exclusive advertisement based on the greater of: (1) the next highest pertinent exclusive display bid, and (2) the sum of the non-exclusive display bids associated with each multiple display slot, should a multiple display outcome have been determined.

If C is less than D, then the method 700 proceeds to step 708, at which it is determined to display multiple advertisements. Following step 708, the method 700 proceeds to step 712, at which the method 700 determines price associated with display of each of the multiple advertisements based on the greater of: (1) the next highest pertinent bid for non-exclusive display; and (2) an amount that must be added to the sum of the non-exclusive display bids associated with each multiple display slot, excluding the subject bid, to at least equal the amount of the highest exclusive display bid. The subject bid is the bid associated with the advertisement display for which a price is being determined.

In Next Price auction mechanism pricing according to embodiments as described in FIG. 7, over-bidding to assure an exclusive or multiple display outcome can be deterred. For example, if the highest exclusive bidder bids excessively high, she may ensure an exclusive outcome, but even if the second highest exclusive bid is very low, she will at least be priced an amount based on the sum of all pertinent multiple display bids. Similarly, if a highest non-exclusive bidder bids excessively high, she may ensure a multiple outcome, but even if the second highest non-exclusive bid is very low, she will at least be priced an amount as described at step 712 of FIG. 7.

The foregoing description is intended merely to be illustrative, and other embodiments are contemplated within the spirit of the invention.

1. A method for use in an online advertising auction, comprising:
using one or more computers, obtaining a plurality of bid expressions, associated with advertisers, for use in an online advertising auction;
wherein each of the plurality of bid expressions specifies at least a first bid and a second bid, and wherein each of the first bid and the second bid specify different amounts that an advertiser is willing to pay for display of a first advertisement in association with a serving opportunity deemed to meet specified criteria;
and wherein the first bid and the second bid specify different amounts that the advertiser is willing to pay depending on different specified sets of one or more externality conditions, wherein an externality condition is a condition relating to display or non-display of one or more advertisements, other than the first advertisement, with display of the first advertisement;
using one or more computers, determining winning bids, of bid expressions of the plurality of bid expressions, wherein one or more externality conditions, associated with display of advertisements in association with winning bids, satisfy sets of one or more externality conditions associated with the winning bids;
using one or more computers, determining pricing for display of advertisements associated with the winning bids, wherein the pricing is based at least in part on bid expressions of the plurality of bid expressions; and
using one or more computers, facilitating serving of advertisements associated with the winning bids.

2. The method of claim 1, comprising serving of advertisements associated with the winning bids.

3. The method of claim 1, comprising obtaining the plurality of bid expressions, wherein each of the plurality of bid expressions comprises a bid for display of an associated advertisement exclusively, and wherein each of the plurality of bid expressions comprises a bid for display of an associated advertisement non-exclusively, wherein an exclusively displayed advertisement is an advertisement that is displayed without other advertisements, and wherein a non-exclusively displayed advertisement is an advertisement that is displayed with other bids.

4. The method of claim 1, comprising obtaining the plurality of bid expressions, wherein each bid expression comprises a higher bid for exclusive serving of an associated advertisement and a lower bid for non-exclusive display of an associated advertisement.

5. The method of claim 1, comprising obtaining the plurality of bids, and wherein each of the plurality of bid expressions comprises at least one bid associated with externality conditions relating to characteristics of advertisements to be displayed with the advertisement associated with the bid.

6. The method of claim 1, comprising a method for use in an online advertising auction, wherein the online advertising auction is a GSP2d auction.

7. The method of claim 1, comprising a method for use in an online advertising auction, wherein the online advertising auction is a Next Price auction.

8. A system for use in operation of an online advertising exchange, comprising:
one or more server computers coupled to a network; and
one or more databases coupled to the one or more server computers;
wherein the one or more server computers are for:
obtaining a plurality of bid expressions, associated with advertisers, for use in an online advertising auction;
wherein each of the plurality of bid expressions specifies at least a first bid and a second bid, and wherein each of the first bid and the second bid specify different amounts that an advertiser is willing to pay for display of a first advertisement in association with a serving opportunity deemed to meet specified criteria;
and wherein the first bid and the second bid specify different amounts that the advertiser is willing to pay depending on different specified sets of one or more externality conditions, wherein an externality condition is a condition relating to display or non-display of one or more advertisements, other than the first advertisement, with display of the first advertisement;
determining winning bids, of bid expressions of the plurality of bid expressions, wherein one or more externality conditions, associated with display of advertisements in association with winning bids, satisfy sets of one or more externality conditions associated with the winning bids;
determining pricing for display of advertisements associated with the winning bids, wherein the pricing is based at least in part on bid expressions of the plurality of bid expressions; and
facilitating serving of advertisements associated with the winning bids.

9. The system of claim 8, wherein the network includes the Internet.

10. The system of claim 8, comprising serving of advertisements associated with the winning bids.

11. The system of claim 8, comprising obtaining the plurality of bid expressions, wherein each of the plurality of bid expressions comprises a bid for display of an associated advertisement exclusively, and wherein each of the plurality of bid expressions comprises a bid for display of an associated advertisement non-exclusively, wherein an exclusively displayed advertisement is an advertisement that is displayed without other advertisements, and wherein a non-exclusively displayed advertisement is an advertisement that is displayed with other bids.

12. The system of claim 8, comprising obtaining the plurality of bid expressions, wherein each bid expression comprises a higher bid for exclusive serving of an associated advertisement and a lower bid for non-exclusive display of an associated advertisement.

13. The system of claim 8, wherein the advertisements associated with the winning bids are sponsored search advertisements, and comprising serving the sponsored search advertisements.

14. The system of claim 8, wherein the advertisements associated with the winning bids are non-sponsored search graphical advertisements and comprising serving the non-sponsored search graphical advertisements.

15. The system of claim 8, comprising obtaining the plurality of bids, and wherein each of the plurality of bid expressions comprises at least one bid associated with externality conditions relating to characteristics of advertisements to be displayed with the advertisement associated with the bid.

16. The system of claim 8, wherein the online advertising auction is a GSP2d auction.

17. The system of claim 8, comprising a method for use in an online advertising auction, wherein the online advertising auction is a Next Price auction.

18. A computer readable medium or media containing instructions for executing a method relating to operating an online advertising exchange, the method comprising:
using one or more computers, obtaining a plurality of bid expressions, associated with advertisers, for use in an online advertising auction;
wherein each of the plurality of bid expressions specifies at least a first bid and a second bid, and wherein each of the first bid and the second bid specify different amounts that an advertiser is willing to pay for display of a first advertisement in association with a serving opportunity deemed to meet specified criteria;
and wherein the first bid and the second bid specify different amounts that the advertiser is willing to pay depending on different specified sets of one or more externality conditions, wherein an externality condition is a condition relating to display or non-display of one or more advertisements, other than the first advertisement, with display of the first advertisement;
and wherein each of the plurality of bid expressions comprises a bid for display of an associated advertisement exclusively, and wherein each of the plurality of bid expressions comprises a bid for display of an associated advertisement non-exclusively, wherein an exclusively displayed advertisement is an advertisement that is displayed without other advertisements, and wherein a non-exclusively displayed advertisement is an advertisement that is displayed with other bids;
using one or more computers, determining winning bids, of bid expressions of the plurality of bid expressions, wherein one or more externality conditions, associated with display of advertisements in association with winning bids, satisfy sets of one or more externality conditions associated with the winning bids;
using one or more computers, determining pricing for display of advertisements associated with the winning bids, wherein the pricing is based at least in part on bid expressions of the plurality of bid expressions; and
using one or more computers, serving advertisements associated with the winning bids.

19. The computer-readable medium or media of claim 18, wherein the online advertising auction is a GSP2d auction.

20. The computer-readable medium or media of claim 18, wherein the online advertising auction is a Next Price auction.
